(19) United States
(12) Patent Application Publication
(10) Pub. No.: US 2015/0302279 A1
(43) Pub. Date: Oct. 22, 2015

(54) Run Length Compression Mechanism

(71) Applicants: Michael Jeffrey Holley, Lyons, CO (US); John Thomas Varga, Longmont, CO (US); Alexandru-Virgil Panek, Ghiroda (RO)

(72) Inventors: Michael Jeffrey Holley, Lyons, CO (US); John Thomas Varga, Longmont, CO (US); Alexandru-Virgil Panek, Ghiroda (RO)

(73) Assignee: Ricoh Company, Ltd., Tokyo (JP)

(21) Appl. No.: 14/753,224

(22) Filed: Jun. 29, 2015

Related U.S. Application Data
(63) Continuation-in-part of application No. 12/644,759, filed on Dec. 22, 2009.

(51) Int. Cl. G06K 15/02; H04L 12/741

(52) U.S. Cl. CPC G06K 15/18; H04L 45/74

(57) ABSTRACT

A method is disclosed. The method includes receiving a data stream and performing Run Length Limited (RLL) encoding to encode the data stream, including adjusting run types and lengths and aligning headers to boundaries of a decoding system.

### CROSS REFERENCE TO RELATED APPLICATIONS

The present patent application is a Continuation-in-Part application claiming priority to application Ser. No. 12/644,759, filed Dec. 22, 2009, which is pending.

### FIELD OF THE INVENTION

The invention relates to the field of decoding systems and, in particular, to parallel decoding of Run Length Limited (RLL) encoded data streams.

### BACKGROUND

Print data transmitted between various processes within a printing system is typically encoded to reduce the amount of bandwidth required to transmit the data. Before the encoded print data is finally printed, the print data is decoded. In some cases, however, the printing speed of the printing system is not limited by a print engine printing the data, but instead by the speed at which the printing system decodes the print data prior to printing the data.

One type of data encoding is RLL encoding. RLL encoding is a lossless compression scheme that bounds the length of runs of repeat data during which the signal does not change. Apple Computer, Inc. introduced a RLL encoding scheme with the release of the Macintosh® computer called PackBits. A PackBits data stream includes packets with a one-byte header followed by one or more bytes of data. The header is a signed byte, which defines the following data as either literal data or repeat data. The header also defines the number of bytes of encoded literal data or encoded repeat data. In other words, the header encodes both the type of data (literal or repeat) and the amount of encoded data.

One problem with decoding RLL data streams, such as PackBits, is that the decoding scheme typically requires serial processing of each byte of the data stream to determine how to treat each subsequent byte of the data stream. The serial processing of each byte of the data stream can limit the performance of systems relying on the decoded output of a RLL data stream, such as printing systems.

However, even in parallel decode schemes, there are scenarios in which lower performance may occur due to worst case compression patterns and header alignment. Such scenarios that are below a minimum performance threshold need to be addressed to ensure a system attains its minimum performance target.

### SUMMARY

In one embodiment, a method is disclosed. The method includes receiving a data stream and performing Run Length Limited (RLL) encoding to encode the data stream, including adjusting run types and lengths and aligning headers to boundaries of a decoding system.

### BRIEF DESCRIPTION OF THE DRAWINGS

A better understanding of the present invention can be obtained from the following detailed description in conjunction with the following drawings, in which:

FIG. 1 is a block diagram of one embodiment of a printing system;

FIG. 2 is a block diagram of one embodiment of a print controller;

FIG. 3 illustrates an embodiment of a run length limited encoded data stream;

FIG. 4 illustrates one embodiment of a decoder;

FIG. 5 is a flow diagram illustrating one embodiment of a method of decoding a run length limited encoded data stream;

FIG. 6 illustrate embodiments of header decode analysis;

FIG. 7 is a flow diagram illustrating one embodiment of a compression process; and

FIG. 8 illustrates one embodiment of a computer system.

### DETAILED DESCRIPTION

A run length compression mechanism is described. In the following description, for the purposes of explanation, numerous specific details are set forth in order to provide a thorough understanding of the present invention. It will be apparent, however, to one skilled in the art that the present invention may be practiced without some of these specific details. In other instances, well-known structures and devices are shown in block diagram form to avoid obscuring the underlying principles of the present invention.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

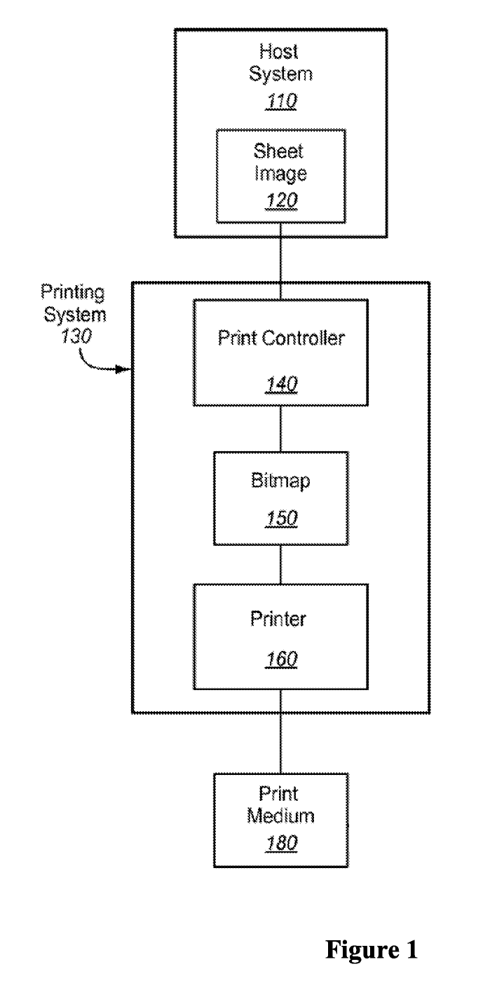

FIG. 1 is a block diagram illustrating one embodiment of a printing system 130. A host system 110 is in communication with the printing system 130 to print a sheet image 120 onto a print medium 180 (e.g., paper) via a printer 160. The resulting print medium 180 may be printed in color and/or in any of a number of gray shades, including black and white (e.g., Cyan, Magenta, Yellow, and blacK, (CMYK)). The host system 110 may include any computing device, such as a personal computer, a server, or even a digital imaging device, such as a digital camera or a scanner.

The sheet image 120 may be any file or data that describes how an image on a sheet of print medium 180 should be printed. For example, the sheet image 120 may include PostScript data, Printer Command Language (PCL) data, and/or any other printer language data. The print controller 140 processes the sheet image to generate a bitmap 150 for printing to the print medium 180 via the printer 160. The printing system 130 may be a high-speed printer operable to print relatively high volumes (e.g., greater than 100 pages per minute). The print medium 180 may be continuous form paper, cut sheet paper, and/or any other tangible medium suitable for printing. The printing system 130, in one generalized form, includes the printer 160 that presents the bitmap 150 onto the print medium 180 (e.g., via toner, ink, etc.) based on the sheet image 120.

The print controller 140 may be any system, device, software, circuitry and/or other suitable component operable to transform the sheet image 120 for generating the bitmap 150 in accordance with printing onto the print medium 180. In this regard, the print controller 140 may include processing and data storage capabilities.

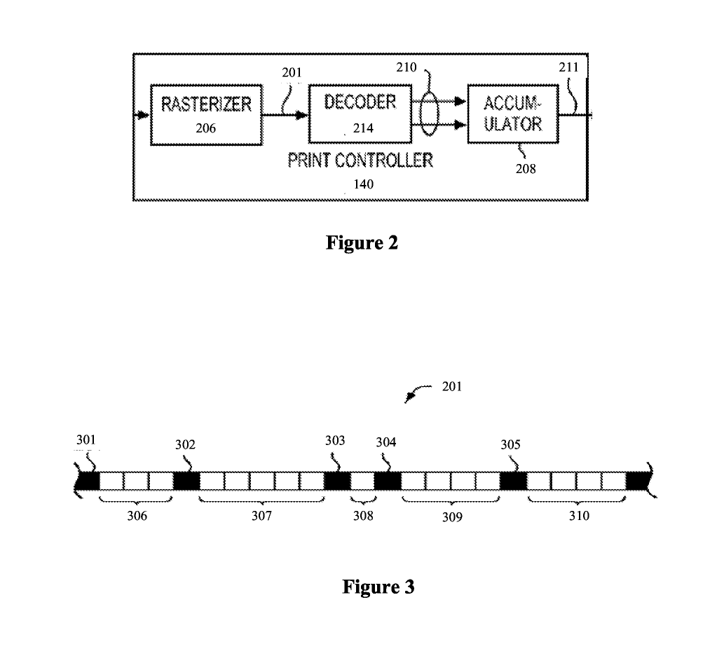

FIG. 2 is a block diagram illustrating another embodiment of a print controller 140. In this embodiment, print controller 140 includes one or more rasterizers 206 operable to receive PDL print data from host system 110, such as PostScript data, PDF (Portable Document Format) data, Intelligent Printer Data Stream (IPDS) data, Advanced Function Presentation (AFP) data, Mixed Object: Document Content Architecture (MODCA), or other types of PDL data and generate RLL encoded data stream 201. Print controller 140 may also include one or more accumulators 208 operable to receive decoded output 210, and generate decoded data stream 211 for printer 160. Accumulator 208 may, for example, combine the parallel-decoded output streams generated by decoder 214 to maintain the correct temporally sequential relationship between data within data stream 201 and data within datastream 211.

FIG. 3 illustrates one embodiment of a RLL encoded data stream 201. Data stream 201 includes headers 301-305 and data blocks 306-310, each of which may include one or more bits or bytes of header or data. In data stream 201, headers 301-305 define respective data blocks 306-310. For example, header 301 defines data block 306 and header 302 defines data block 307. In like manner, header 303 defines data block 308, header 304 defines data block 309, and header 305 defines data block 310. For example, headers 301-305 may define a type of RLL encoding or a number of encoded elements of respective data blocks 306-310. Although data stream 201 illustrates a specific configuration of headers 301-305 and data blocks 306-310, one skilled in the art will recognize that data stream 201 may comprise various combinations of headers and data blocks. Thus, data stream 201 is not limited to the specific configuration illustrated in FIG. 3.

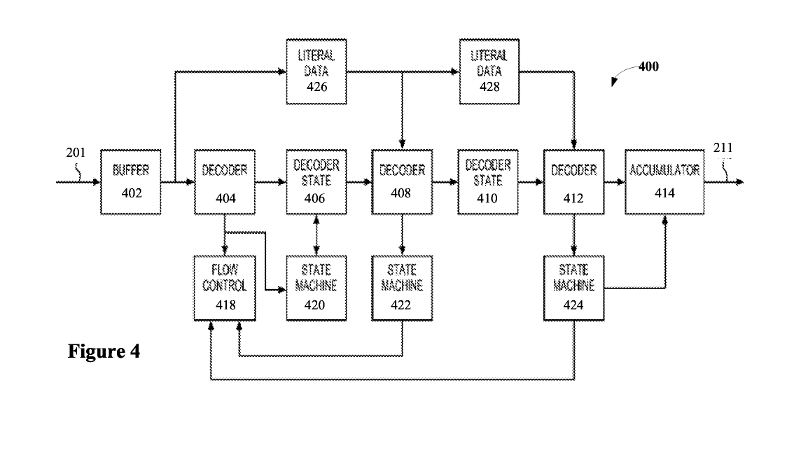

FIG. 4 illustrates one embodiment of a decoding system 400. Decoding system 400 is embodied as programmable logic on a programmable logic device, although one skilled in the art will recognize that decoding system 400 may have alternate embodiments. For example, decoding system 400 may be implemented within printer 160 in FIG. 1.

In FIG. 4, decoding system 400 is operable to decode a PackBits encoded data stream 201 in parallel to generate decoded output 211. In this embodiment, decoding system 400 is operable to decode up to two headers at a time, process up to eight input bytes per cycle, and generate up to 16 output bytes per cycle. In decoding system 400, the PackBits algorithm is parsed into finite computational elements and coded into three main stages, including two sub-stages for each main stage.

Decoder 404 receives eight bytes of data comprising data stream 201 from buffer 402, decodes the first byte of data stream 201 (for example, first header 302 (see FIG. 3) is considered as the first byte of data stream 201 for continuity of example) into ignore, repeat, or literal data, and computes the number of literal or repeats to identify second header 303. This process is repeated to identify header 304 if header 304 is within the current eight bytes of data. If the location of header 304 is also within the eight bytes of data, then decoder 404 stalls to allow for subsequent decode processing within the eight bytes of data. If the location of header 304 is not within the eight bytes of data, then decoder 404 receives an additional eight bytes of data from buffer 402 to continue processing.

Flow control 418 is a flow control state machine across all decoding stages, collecting stall signals from the decoding stages to halt reads at the system input. Pointer 420 contains information about the current decode location within data stream 201. Literal data 426 and literal data 428 transmit literal data decoded from decoder 404 to decoder 408 and decoder 412. Decode state 406 and 410 track current pointers and counters for each corresponding stages' progress in decoding data streams.

Decoder 408 receives up to two valid header decodes from decoder 404. Decoder 408 implements the repeat byte command by multiplying one to eight bytes of data output. Decoder 408 implements the literal output by accepting from one to eight bytes at a time from decoder 404 and passing the literal output on to decoder 412. Decoder 408 may receive ignore/skip headers from decoder 404, but decoder 408 ignores the ignore/skip headers. Decoder 408 recognizes valid data from decoder 404 by decoding a passed-on header from decoder 404. Decoder 408 will stall using state machine 422 if decoder 404 is implementing a repeat output over multiple cycles.

Decoder 412 accepts valid repeat and literal data from decoder 408. Decoder 412 can process up to two full eight-byte words from decoder 408. Decoder 412 may also be stalled by state machine 424 when buffer 414 is full. State machine 424 may also stall decoder 408 and decoder 404 when this occurs. Accumulator 414 recombines the parallelized multiple decoded data streams while maintaining the original order of the incoming data from decoder 412. It is designed to be twice as wide as the preceding data path to accommodate dual streams of data without causing a stall in the decode stages. Its ability to output 16 bytes at a time allows the overall throughput to stay very high even if a decode stalls occasionally due to poor compression.

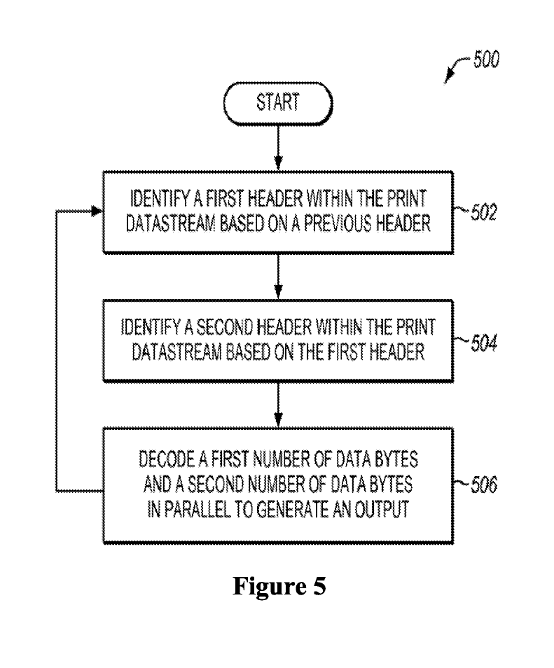

FIG. 5 is a flow diagram illustrating one embodiment of a method 500 for decoding a run length limited encoded data stream. Method 500 may be performed by processing logic that may comprise hardware (e.g., circuitry, dedicated logic, programmable logic, etc.), software (such as instructions run on a processing device), or a combination thereof. In one embodiment, method 500 may be performed by print controller 140. The processes of method 500 are illustrated in linear sequences for brevity and clarity in presentation; however, it is contemplated that any number of them can be performed in parallel, asynchronously, or in different orders. For brevity, clarity, and ease of understanding, many of the details discussed with reference to FIGS. 1-4 are not discussed or repeated here.

At processing block 502, print controller 140 identifies first header 302 within datastream 201 based on previous header 301. For example, rasterizer 206 may receive PDL print data from host system 110, and convert the PDL print data into data stream 201. If data stream 201 is a PackBits datastream, print controller 140 may first identify previous header 301 as defining literal data. In a PackBits data stream, headers may comprise literal headers, repeat headers, or indicate a skip header. Table 1 illustrates how headers are encoded in PackBits:

TABLE 1

| Header (n) | Data Following the Header |
|---|---|
| 0 to 127 | (1 + n) literal bytes of data |
| −1 to −127 | One byte of data repeated (1 − n) times in the decompress- |
| | ed output |
| −128 | No operation (skip and treat the next byte as a header byte) |

When the signed header ranges from 0 to 127, the header defines the bytes subsequent to the header in the datastream as literal data. The value of the header also defines the number of bytes of literal data as 1+n, where n is the signed value of the header. For example, if previous header 301 has a value of 2, then previous header 301 defines that the next 3 bytes in data stream 201 are literal data bytes. This is indicated by data block 306 in FIG. 3, which spans 3 blocks of data.

After print controller 140 identifies previous header 301, print controller 140 may generate an offset within data stream 201 to locate first header 302 based on previous header 301. In the example, previous header 301 defines 3 bytes of literal encoded data (e.g., previous header 301 has a value of 2 such that previous header 301 defines 2+1 bytes of subsequent literal data in data stream 201). Thus, print controller 140 may calculate a 4 byte offset (i.e., 1 header byte plus 3 data bytes) from previous header 301 to locate first header 302. After locating first header 302 in data stream 201, print controller 140 may identify, for example, that first header 302 has a value of 4. Because first header 302 resides within the range from 0 to 127, first header 302 also defines 5 bytes (i.e., 4+1) of literal data in data stream 301. This is indicated by data block 307.

At processing block 504, print controller 140 identifies a second header 303 within data stream 201 based on first header 302. In continuing with the example, first header 302 defines 5 bytes of literal encoded data. Print controller 140 may then identify second header 303 within data stream 201 based on a 6 byte offset (1 header byte plus 5 data bytes) from first header 302. After locating second header 303 in data stream 201, print controller 140 may then identify second header 303 as defining repeat encoded data.

Referring again to Table 1 above, when the header value resides within a range of −1 to −127, the header defines one byte of data repeated 1-n times in the decoded output. For example, if a header has a value of −5, then the header defines that the following byte is repeated 6 times in the decoded output. Because the data byte is repeated, only one byte of data is used to represent the decoded output.

At processing block 506, print controller 140 decodes the first number of data bytes defined by first header 302 at processing block 502 (i.e., data block 307) in parallel with the second number of data bytes defined by second header 303 at processing block 504 (i.e., data block 307) to generate output 211. As subsequent processing remains for data stream 201 for decoding, processing returns to processing block 502. Steps 502-506 will be described with reference to headers 304 and 305 and data blocks 309 and 310 in FIG. 3.

Returning to processing block 502, print controller 140 identifies header 304 based on header 303 (previously as second header 303). In the example, header 303 defines repeat encoded data. Thus, header 303 defines one byte of data, repeated (1-n) times in the decoded output. Print controller 140 may then identify header 304 based on a 2 byte offset (1 header byte plus 1 repeat byte). After locating header 304, print controller 140 may then identify header 304, for example, as defining 4 bytes of literal encoded data as indicated in data block 309.

At processing block 504, print controller 140 identifies a header 305 based on header 304. In the example, header 304 defines 4 bytes of literal encoded data. Print controller 140 may then identify header 305 based on a 5 byte offset. After locating header 305, print controller 140 may then identify header 305 as defining 4 bytes of literal data (e.g., header 305 has a value of 4) as indicated in block 310.

At processing block 506, print controller 140 decodes the number of data bytes defined by header 304 at processing block 502 (i.e., data block 309) in parallel with the number of data bytes defined by header 305 at processing block 504 (i.e., data block 310) to generate output 211. Processing data stream 201 continues repeatedly between at processing blocks 502-506 until data stream 201 is decoded in its entirety. After print controller 140 generates output the, accumulator 414 combines the output 210 into a data stream to generate a printed output.

The implementation of method 500 may result in an occurrence of lower performance upon receiving worst case compression patterns and header alignment to an 8-byte input word received at decoding system 400. In one embodiment, decoding system 400 decodes two headers during each clock cycle, with an average of 3.5 bytes being processed per cycle. However, there are several cases in which the resulting processing is below a minimum performance threshold to ensure that decoding system 400 attains minimum performance target.

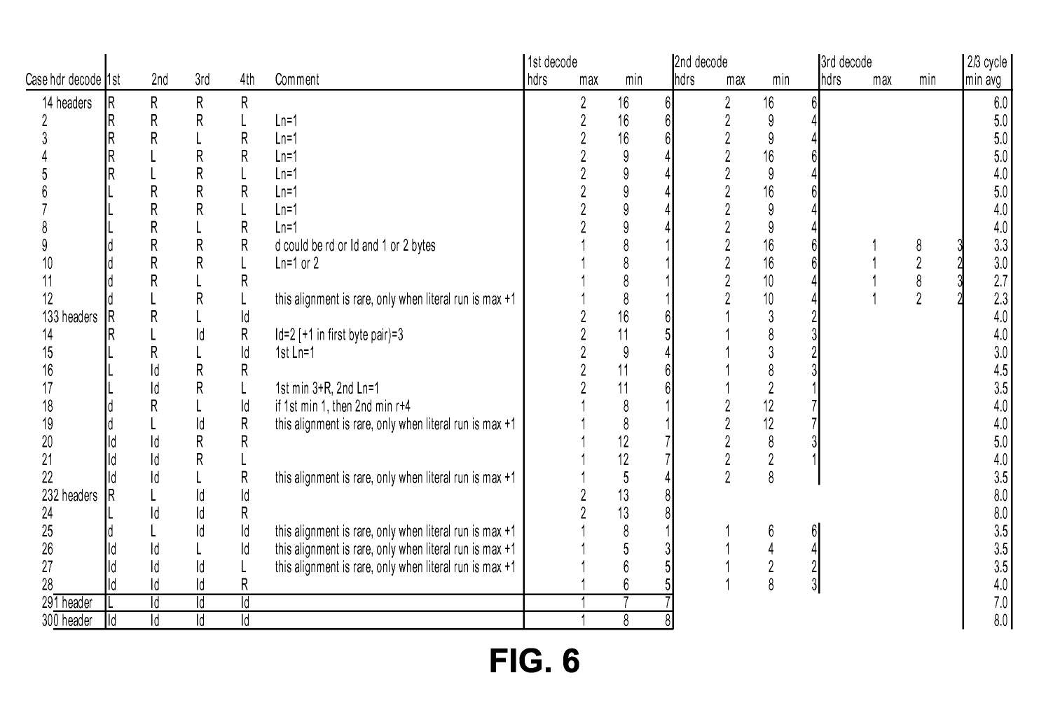

FIG. 6 illustrates a header decode analysis for all possible combinations of headers, run lengths and alignment. As shown in FIG. 6, several cases (e.g., 12, 19, 22, 26 and 27) result in an occurrence of decoding system 400 performance that is below the minimum performance threshold. The low bandwidth performance cases have several things in common, such as low counts (for both literal and repeat runs) and misalignment of the headers to the 8-byte decode word.

According to one embodiment, PackBits data is encoded to maximize the performance of decoding system 400. In such an embodiment, print controller 140 processes the data stream in order to adjust the PackBits compression algorithm. As a result, run types and lengths are adjusted and the headers are aligned to 8-byte word boundaries used in decoding system 400 to avoid the low bandwidth cases shown in FIG. 6. As shown in FIG. 6, L represents a literal run, while R represents a repeat run

According to one embodiment, alignment is achieved by using only odd literals. Such an embodiment results in automatic header alignment. In another embodiment, alignment may be achieved by adding No operation headers as padding. In yet another embodiment, short literal runs are forced to push the next header to the proper alignment. In still another embodiment, short runs that cause the low bandwidth cases are minimized. Header alignment results in elimination of almost all of the low bandwidth corner cases. However, to accommodate the few cases where the alignment still produced low bandwidth, a one time increase in the Rmin is performed when preceded by an Lmin run, where Rmin represents the fewest number of identical pixels that can be coded and Lmin is the smallest literal run of pixels that is allowed.

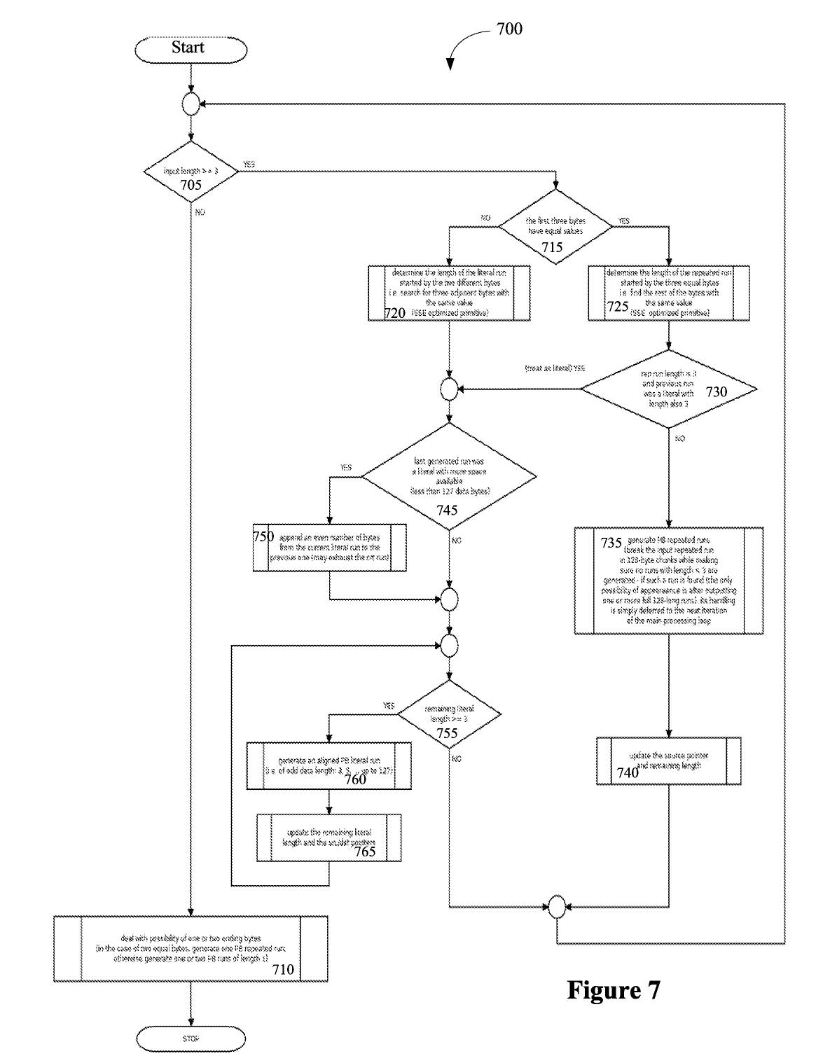

FIG. 7 is a flow diagram illustrating one embodiment of a method 700 for compressing data. Method 700 may be performed by processing logic that may comprise hardware (e.g., circuitry, dedicated logic, programmable logic, etc.), software (such as instructions run on a processing device), or a combination thereof. In one embodiment, method 700 may be performed by print controller 140. The processes of method 700 are illustrated in linear sequences for brevity and clarity in presentation; however, it is contemplated that any number of them can be performed in parallel, asynchronously, or in different orders. For brevity, clarity, and ease of understanding, many of the details discussed with reference to FIGS. 1-6 are not discussed or repeated here.

At decision block 705, a determination is made as to whether an input length of the remaining pixels in the scan line is greater than or equal to 3 bytes. If the input length is less than 3 bytes, processing block 710 deals with a possibility of one or two ending bytes. In one embodiment, one repeated run is generated in the case of two equal bytes. Otherwise, one or two runs of length one is generated.

If at decision block 705 the input length is greater than or equal to 3 bytes, a determination is made as to whether the first 3 bytes have equal values, decision block 715. If not, the length of the literal run started by the two different bytes is determined, processing block 720. Otherwise, the length of the repeated run started by the three equal bytes is determined, processing block 725. At decision block 730, a determination is made as to whether the repeated run length is 3 bytes and the previous run was a literal also with a run length is 3 bytes.

If not, the repeated runs are generated, processing block 735. At processing block 740, a source pointer and the remaining length are updated. Subsequently, control is returned to decision clock 705 where a determination is made as to whether an input length of the remaining pixels of the scan line is greater than or equal to 3 bytes. If at decision block 730 a determination is made that the repeated run length is 3 bytes and the previous run was a literal also with a run length of 3 bytes, or after processing block 720, a determination is made as to whether the last generated run was a literal with more space available (e.g., less than 127 data bytes), decision block 745.

If so, an even number of bytes from the current literal run is appended to the previous literal run, processing block 750. Subsequently, or if determined that the last generated run was not a literal with more space available, a determination is made as to whether the remaining literal length is greater than or equal to 3 bytes, decision block 755. If the remaining literal length is less than 3 bytes, control is returned to decision clock 705 where a determination is made as to whether an input length of the remaining pixels of the scan line is greater than or equal to 3 bytes.

If the remaining literal length allowed is greater than or equal to 3 bytes, an aligned literal run of odd length is generated, processing block 760. At processing block 765, the remaining literal length and source/destination pointers are updated. Subsequently, control is returned to decision block 755 where a determination is made as to whether the remaining literal length is greater than or equal to 3 bytes. This process continues for each scan line until the remaining literal length is less than 3 bytes.

The above-described process generates a Packbits compression in which repeat runs have odd lengths so that the run+header has an even number of pixels. Moreover, repeated runs of only 3 are allowed only if a previous header was not a literal of size 3. By these constraints, decoding system 400 may operate on an alignment scheme that optimizes the ability to decode literal runs and repeats at a higher efficiency than a Packbits encoding aimed at only minimizing a final compressed byte size.

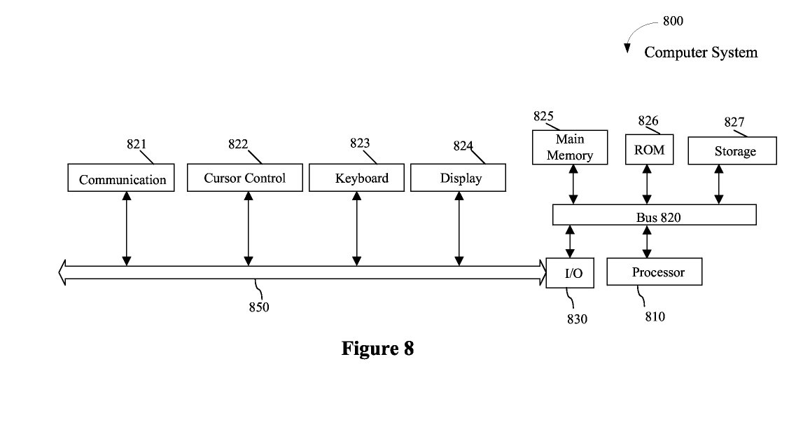

FIG. 8 illustrates a computer system 800 on which printing system 130 may be implemented. Computer system 800 includes a system bus 820 for communicating information, and a processor 810 coupled to bus 820 for processing information.

Computer system 800 further comprises a random access memory (RAM) or other dynamic storage device 827 (referred to herein as main memory), coupled to bus 720 for storing information and instructions to be executed by processor 810. Main memory 827 also may be used for storing temporary variables or other intermediate information during execution of instructions by processor 810. Computer system 800 also may include a read only memory (ROM) and or other static storage device 826 coupled to bus 820 for storing static information and instructions used by processor 810.

A data storage device 825 such as a magnetic disk or optical disc and its corresponding drive may also be coupled to computer system 800 for storing information and instructions. Computer system 800 can also be coupled to a second I/O bus 850 via an I/O interface 830. A plurality of I/O devices may be coupled to I/O bus 850, including a display device 824, an input device (e.g., an alphanumeric input device 823 and or a cursor control device 822). The communication device 821 is for accessing other computers (servers or clients). The communication device 821 may comprise a modem, a network interface card, or other well-known interface device, such as those used for coupling to Ethernet, token ring, or other types of networks.

Embodiments of the invention may include various steps as set forth above. The steps may be embodied in machine-executable instructions. The instructions can be used to cause a general-purpose or special-purpose processor to perform certain steps. Alternatively, these steps may be performed by specific hardware components that contain hardwired logic for performing the steps, or by any combination of programmed computer components and custom hardware components.

Elements of the present invention may also be provided as a machine-readable medium for storing the machine-executable instructions. The machine-readable medium may include, but is not limited to, floppy diskettes, optical disks, CD-ROMs, and magneto-optical disks, ROMs, RAMs, EPROMs, EEPROMs, magnetic or optical cards, propagation media or other type of media/machine-readable medium suitable for storing electronic instructions. For example, the present invention may be downloaded as a computer program which may be transferred from a remote computer (e.g., a server) to a requesting computer (e.g., a client) by way of data signals embodied in a carrier wave or other propagation medium via a communication link (e.g., a modem or network connection).

Whereas many alterations and modifications of the present invention will no doubt become apparent to a person of ordinary skill in the art after having read the foregoing description, it is to be understood that any particular embodiment shown and described by way of illustration is in no way intended to be considered limiting. Therefore, references to details of various embodiments are not intended to limit the scope of the claims, which in themselves recite only those features regarded as essential to the invention.

What is claimed is:

1. A machine-readable medium including data that, when accessed by a machine, cause the machine to perform operations comprising:
receiving a data stream; and
performing Run Length Limited (RLL) encoding to encode the data stream, including:
adjusting run types and lengths; and
aligning headers to boundaries of a decoding system.

2. The machine readable medium of claim 1 wherein aligning the headers comprises using only odd literal headers.

3. The machine readable medium of claim 1 wherein aligning the headers comprises using only a minimum repeat header length of 3.

4. The machine readable medium of claim 1 wherein aligning the headers comprises adding No operation headers as padding.

5. The machine readable medium of claim 1 wherein aligning the headers comprises forcing short literal runs to push a next header to proper alignment.

6. The machine readable medium of claim 1 wherein aligning the headers comprises minimizing short literal runs.

7. The machine readable medium of claim 1 including data that, when accessed by a machine, cause the machine to further perform operations comprising decoding the encoded data stream, including:
identifying a first header within the encoded data stream that defines a first number of data blocks subsequent to the first header and a first RLL encoding of the first number of data blocks;
identifying a following header within the data stream that defines a following number of data blocks subsequent to the following header and a following RLL encoding of the following number of data blocks; and
decoding the first number of data blocks based on the first RLL encoding and the following number of data blocks based on the following RLL encoding in parallel to generate an output.

8. The machine readable medium of claim 7 wherein identifying the first header further comprises identifying the first header based on a previous header and a previous number of data blocks preceding the first header in the encoded data stream and identifying the following header further comprises identifying the following header based on the first header and the first number of data blocks subsequent to the first header.

9. A printing system comprising:
a decoding system; and
a print controller to receive a data stream and perform Run Length Limited (RLL) encoding to encode the data stream, including adjusting run types and lengths; and aligning headers to boundaries of the decoding system.

10. The printing system of claim 9 wherein aligning the headers comprises using only odd literal headers.

11. The printing system of claim 9 wherein aligning the headers comprises using only a minimum repeat header length of 3.

12. The printing system of claim 9 wherein aligning the headers comprises adding No operation headers as padding.

13. The printing system of claim 9 wherein aligning the headers comprises forcing short literal runs to push a next header to proper alignment.

14. The printing system of claim 9 wherein aligning the headers comprises minimizing short literal runs.

15. The printing system of claim 9 wherein the decoding system identifies a first header within the encoded data stream that defines a first number of data blocks subsequent to the first header and a first RLL encoding of the first number of data blocks, identifies a following header within the data stream that defines a following number of data blocks subsequent to the following header and a following RLL encoding of the following number of data blocks and decodes the first number of data blocks based on the first RLL encoding and the following number of data blocks based on the following RLL encoding in parallel to generate an output.

16. A method comprising:
receiving a data stream; and
performing Run Length Limited (RLL) encoding to encode the data stream, including:
adjusting run types and lengths; and
aligning headers to boundaries of a decoding system.

17. The method of claim 16 wherein aligning the headers comprises using only odd literal headers.

18. The method of claim 16 wherein aligning the headers comprises using only a minimum repeat header length of 3.

19. The method of claim 16, wherein aligning the headers comprises adding No operation headers as padding.

20. The method of claim 16, wherein aligning the headers comprises forcing short literal runs to push a next header to proper alignment.
